(19) United States
(12) Patent Application Publication
(10) Pub. No.: US 2010/0126025 A1
(43) Pub. Date: May 27, 2010

(54) Loppers

(76) Inventors: Randy Crockett, Booneville, AR (US); Deanne Crockett, Booneville, AR (US)

Correspondence Address: DENNIS B. HAASE, P.O. BOX 6206, HOT SPRINGS, AR, 71902-6206, US

(21) Appl. No.: 12/313,380

(22) Filed: Nov. 21, 2008

(51) Int. Cl. B26B 17/00

(52) U.S. Cl. 30/188

(57) ABSTRACT

A lopper of use by those who, for one reason or the other, find it difficult to bend over sufficiently to cut unwanted plant material at or near ground level. The lopper has a jaw which is parallel to the ground with the user standing and the user is able to anchor one of the blades of the lopper while manipulating the other blade toward and away from the anchored blade to cut plant material between them at or near ground level.

The present invention relates, in a general sense, to devices to assist those having neither the ability, nor the inclination to bend over to perform gardening tasks and is, more particularly, to a novel, manually operable, device for cutting and trimming unwanted plant material such as small trees, shrubs and brush.

### BACKGROUND OF THE INVENTION

1. Field of the Invention

In practically every yard there are plants which are, at a minimum, undesirable. Such plants include, but are not limited to, small trees, brush and shrubs. This is not to say that all undesirables are weeds. In many areas of the country, fugitive plants spring up from seeds carried by wind or birds and are neither planned nor hoped for.

In another scenario, property owners occasionally re evaluate their plantings and may change their view of their yard. They may decide that a particular planting needs to be removed or relocated. Options available to the owner, other than hiring another to do the work, include digging up the planting and cutting it off.

Persons wanting to do yard work such as just described, may be arthritic, suffer from back problems or, in some fashion, find it difficult to impossible to bend over to a sufficient extent in order to cut off plants which one wishes to have removed.

How then can a person charged with cutting off such plants accomplish the task without undue discomfort or injury? The present invention answers the question.

2. Overview of the Related Art

Virtually everyone is generally familiar with the venerable lopper which has been used by gardening afficionados for years. The tool features powerful jaws and long handles for leverage.

There being no genuinely related art, a search migrated into the art of shears used primarily for cutting metals. Among that art was found Aufderheide U.S. Pat. No. 518,129 having linkage to create a mechanical advantage. The mechanical advantage permits the user to multiply the force he is able to apply to a sheet of steel or the like to cut or shear it, despite the fact that it is a tough material.

Of general interest is the horn U which is inserted into the bench upon which it is used [Col. 1, lines 42-45].

Swan U.S. Pat. No. 818,578 is a plate shear, similar in construction to Aufderheide, absent the horn, but similar in purpose to that patent. Burkett U.S. Pat. No. 993,646 is but a simple metal cutting shear.

Roush et al. U.S. Pat. No. 6,526,857 is of interest only to the extent that it suggests a means of increasing the leverage of a conventional bolt cutter by putting one of its handles in a vice.

It should be evident that all of this patent art has its utility in the metal arts, and none of these patented devices are capable of accomplishing the objectives of the present invention.

### SUMMARY OF THE INVENTION

The present invention is expressly designed and constructed to meet a specific need. More particularly, it has as it general objective, providing those who, for whatever reason either can not, or do not wish to, bend over close to the ground to trim or cut out unwanted plant material without resort to expensive power equipment.

It is another objective of the present invention to permit the efficient and effective removal of unwanted shrubs, small trees and the like by anyone, irrespective of the level of their ability to flex and bend.

As an adjunct to the foregoing, it is an additional objective to provide relief to those who wish to do certain lawn work, but for whatever reason are otherwise less able to do so, by providing a tool which permits them to do what they otherwise could not do.

Other objects and advantages of the invention will become apparent to those skilled in the art from a reading of the forthcoming detailed description of a preferred embodiment taken in conjunction with the drawings, wherein:

### DESCRIPTION OF THE DRAWINGS

FIG. 1 is a pictorial view of the improved lopper of the present invention, viewed from the perspective of the user; and,

FIG. 2 is a side elevation of the lopper of FIG. 1, illustrating the structure from a slightly different perspective.

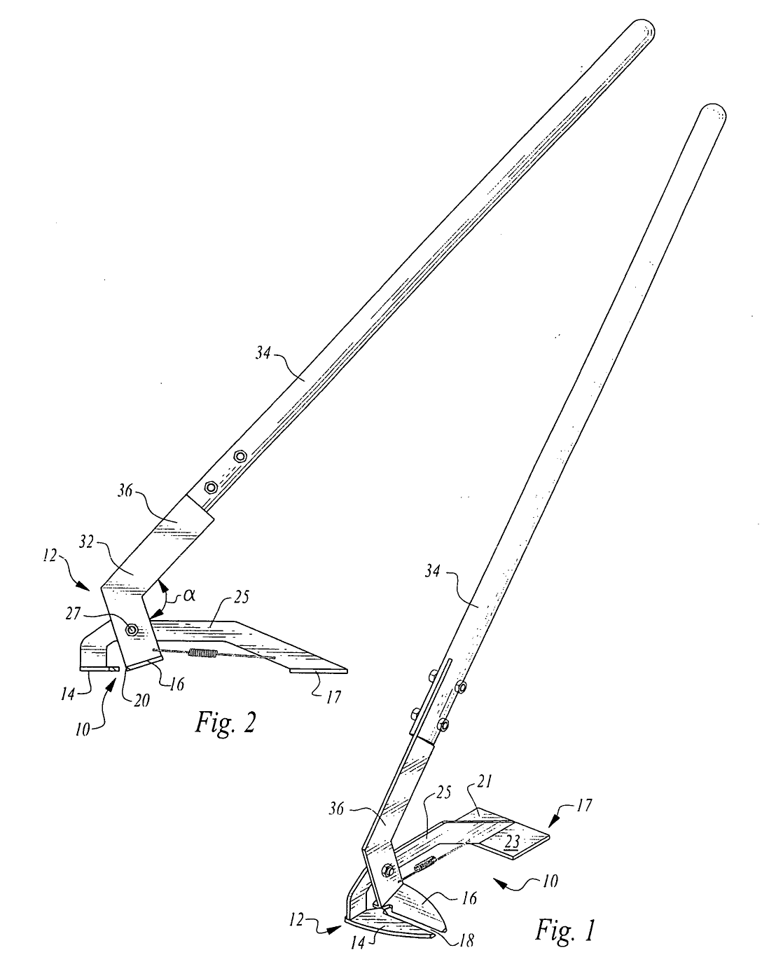

### DETAILED DESCRIPTION OF A PREFERRED EMBODIMENT

Referring now to the drawings, an improved lopper is shown at 10. The lopper 10 includes a set of jaws 12. The jaws 12 comprise a pair of blades 14 and 16 which reside in the same plane, and are movable toward and away from one another between an opened and closed position.

Each of the blades 14, 16 is provided with a sharpened edge 18, 20, respectively. When the jaws are closed, in the cutting mode, the sharpened edges 18, 20 are engaged in a longitudinally extending plane and are capable of shearing off plant material that has been positioned between them.

In furtherance of the objectives of the novel lopper 10, one blade, in this instance the blade 14 of the jaw 12, is removably anchored to the ground. This is accomplished by means of a foot anchored plate 17. The plate 17 is formed, or otherwise provided, with opposed foot receiving steps 21 and 23 supported by an elongated extension member 25. The extension member 25 is affixed to the jaw 14, holding the jaw 14 at right angles to the plane of the extension member 25. In a similar fashion, the plate 17 is secured at right angles to the extension member 25.

It is a feature of the invention that the sharpened edges of the blades are in substantially the same, or parallel plane as the plate 17, thereby permitting the jaws to be positioned at essentially ground level. It will occur to those skilled in art that a minor adjustment in the angular disposition of the extension member 25, would result in a change in the height of the jaws relative to the ground in order to accommodate uneven or obstructed terrain while retaining the planer attitude of the jaws 12.

The lopper 10 is rendered operative as one of the blades, in the illustrated case, the blade 16 of the jaw 12, is rotatable about a pivot point defined by a bolt 27 between an opened and closed position. As illustrated, the pivot bolt 27 creates a pivot point, preferably located relatively perpendicular to the plane of the blades by attaching the blade 16 to the extension member 25, so as to be rotatable relative thereto. The pivot point is precisely located in order that the sharpened edge of the blade 16 will, in the closed position, be aligned and engaged with the sharpened edge of the blade 14.

The blade 16 is formed, or otherwise provided, with an arm 32, and the blade 16 is provided at one end thereof, where it projects at an angle to the arm in order to be coplanar with the blade 14. At the other end of the arm 32, a handle 34 is affixed, in any suitable manner, to the arm. The arm has an angular terminus 36 which is formed at an angle a, and the handle 34 projects upwardly from the arm and, as illustrated, is, thus, disposed at the same angle, which is chosen to be especially ergonomic for the average user of the lopper 10 and is in the neighborhood of 45 degrees. Clearly, it is within the contemplation of the invention that the handle may be at a somewhat different angle so long as it functions in substantially the same way as described.

Operation of the lopper 10 should now be clear. The user finds plant material which he/she wishes to remove. The jaws 12, which is parallel to the ground, is placed on or very near the ground with the blade 14 adjacent the plant material to be removed and the jaws opened. One or both feet of the user are placed on the plate 17 at step 21 or 23 in order to anchor the blade to which it is attached. The handle 34 is then pushed downwardly by the user, rotating the movable blade 16 in a line transverse to the plane of the blades, and the blade 16 is, thus, closed, cutting the plant material at ground level. The excision is accomplished without the user having to bend over close to the ground, thus accomplishing the objectives of the invention.

Those versed in the art will perceive some variation in the several elements of the lopper and its operation. It will be understood, however, that such variations are within the contemplation of the invention as defined in the accompanying claims, wherein:

1. A lopper for use by one not wishing to bend over to remove plant material at or near its base; said lopper comprising:
a set of jaws; said jaws comprising a pair of opposed blades, one of said blades being anchorable to the ground, the other of said blades being rotatable relative to said anchored blade between an open and closed position, whereby plant material between said blades is cut off near to the ground.

2. The lopper of claim 1, wherein said blades reside in the same plane, and said plane being parallel to the ground.

3. The lopper of claim 1, wherein each of said blades is provided with a sharpened edge, and said sharpened edges are engaged in a longitudinal plane when said jaws are in a closed configuration.

4. The lopper of claim 1, wherein one of said blades including an extension, said extension terminating in a plate, said plate adopted to be stepped upon by a user of said lopper to thereby anchor one of said blades relative to said other one of said blades.

5. The lopper of claim 1, wherein said other of said blades including an arm extending therefrom; said arm pivotally secured to said extension, in order that said blade on said arm being movable relative to said anchored one of said blades toward and away from said other of said blades.

6. The lopper of claim 1, wherein a handle is connected to said other of said blades, such pushing on said handle moves said blades to a closed position.

7. The lopper of claim 5, wherein said arm includes an angular terminus.

8. The lopper of claim 7, wherein said terminus is angled at about 45 degrees relative to said arm.

9. The lopper of claim 6, wherein said handle is connected to said arm, said handle projecting upwardly.

10. The lopper of claim 9, wherein movement of said handle in a downwardly direction results in the moving of said jaws to a closed position.

11. The lopper of claim 4, wherein said other of said blades including an arm extending therefrom; said arm pivotally secured to said extension, in order that said blade on said arm being movable relative to said anchored one of said blades toward and away from said other of said blades.

12. The lopper of claim 4, wherein a handle is connected to said other of said blades, such pushing on said handle moves said blades to a closed position.

13. The lopper of claim 5, wherein said arm is rotatable about said pivot in a plane transverse to the plane of said blades.
